(19) United States
(12) Patent Application Publication
(10) Pub. No.: US 2025/0330822 A1
(43) Pub. Date: Oct. 23, 2025

(54) APPARATUS, SYSTEM, AND METHOD OF FAST BASIC SERVICE SET (BSS) TRANSITION (FT)

(71) Applicant: INTEL CORPORATION, Santa Clara, CA (US)

(72) Inventors: Juan Fang, Portland, OR (US); Laurent Cariou, Milizac (FR); Dave Cavalcanti, Portland, OR (US); Necati Canpolat, Beaverton, OR (US)

(73) Assignee: INTEL CORPORATION, Santa Clara, CA (US)

(21) Appl. No.: 18/870,649

(22) PCT Filed: Jun. 30, 2022
(86) PCT No.: PCT/US2022/035640

§ 371 Date: Nov. 30, 2024

(51) Int. Cl. H04W 16/14

(52) U.S. Cl. CPC H04W 16/14

(57) ABSTRACT

For example, a STA may transmit a Fast Basic Service Set (BSS) Transition (FT) request to a target AP via a current AP with which the STA is associated, wherein the FT request is configured to request an FT from the current AP to the target AP; process an FT response from the target AP after the FT request, the FT response received by the STA via the current AP; transmit a reassociation request to the target AP via the current AP after the FT response, the reassociation request to request to associate between the STA and the target AP; process a reassociation response from the target AP after the reassociation request, the reassociation response received by the STA via the current AP; and switch the STA from the current AP to the target AP for communication via an associated session between the STA and the target AP.

### TECHNICAL FIELD

Aspects described herein generally relate to Fast Basic Service Set (BSS) Transition (FT).

### BACKGROUND

In some wireless communication networks, a wireless communication station (STA) may be configured to communicate with an Access Point (AP).

A mobile device may be required to switch communication from a first AP to a second AP, for example, when the STA moves out of range of the first AP.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic illustration of a Multi-Link Device (MLD) Fast Basic Service Set (BSS) Transition (FT) scheme, which may be implemented in accordance with some demonstrative aspects.

FIG. 5 is a schematic illustration of an FT utilizing a backhaul connection, in accordance with some demonstrative aspects.

FIG. 6 is a schematic illustration of communications and operations according to an FT protocol, in accordance with some demonstrative aspects.

FIG. 7 is a schematic flow-chart illustration of a method of FT, in accordance with some demonstrative aspects.

FIG. 8 is a schematic flow-chart illustration of a method of FT, in accordance with some demonstrative aspects.

FIG. 9 is a schematic flow-chart illustration of a method of FT, in accordance with some demonstrative aspects.

FIG. 10 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D1.5 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), March 2022)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by a mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

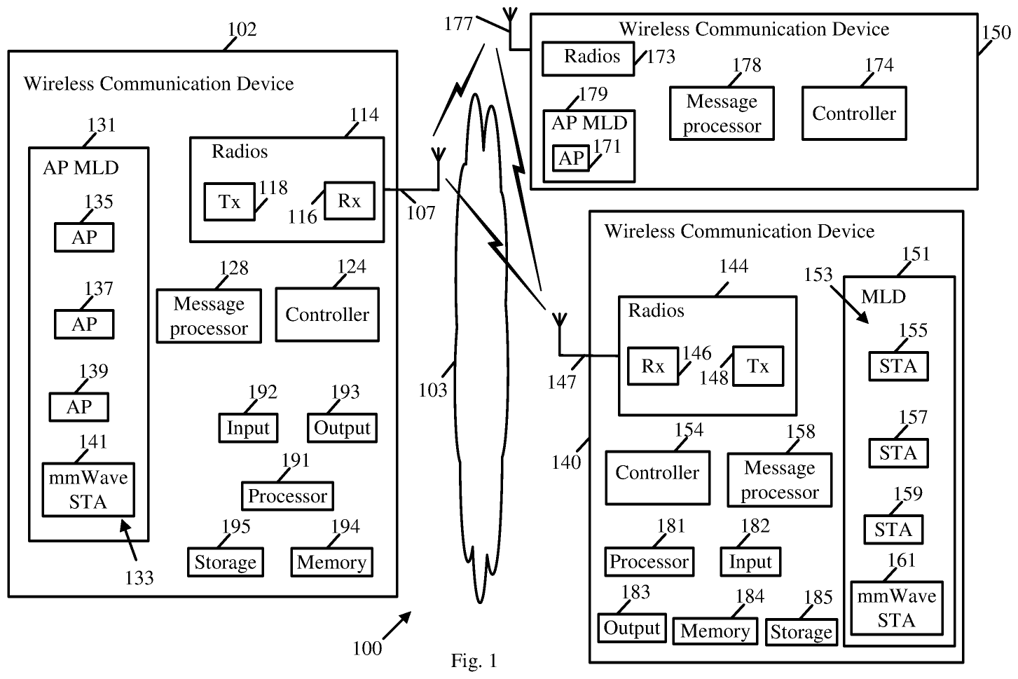

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 150, and/or one or more other devices.

In some demonstrative aspects, devices 102, 140, and/or 150 may include a mobile device or a non-mobile, e.g., a static, device.

For example, devices 102, 140, and/or 150 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 and/or device 150 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102, 140 and/or 150 may optionally include other suitable hardware components and/or software components. In some demonstrative aspects, some or all of the components of one or more of devices 102, 140 and/or 150 may be enclosed in a common housing or packaging, and may be interconnected or operably associated using one or more wired or wireless links. In other aspects, components of one or more of devices 102, 140 and/or 150 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 150 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band.

In other aspects, WM 103 may include any other type of channel over any other frequency band.

In some demonstrative aspects, device 102, device 140, and/or device 150 may include one or more radios including circuitry and/or logic to perform wireless communication between devices 102, 140, 150 and/or one or more other wireless communication devices. For example, device 102 may include one or more radios 114, device 150 may include one or more radios 173, and/or device 140 may include one or more radios 144.

In some demonstrative aspects, radios 114, 173, and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114, 173 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114, 173 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114, 173 and/or 144 may include or may be implemented as part of a wireless Network Interface Card (NIC), and the like.

In some demonstrative aspects, radios 114, 173 and/or 144 may be configured to communicate over a sub-10 Ghz band, for example, 2.4 GHz band, a 5 GHz band, a 6 GHz band, and/or any other sub-10 GHz band; and/or an mmWave band, e.g., a 45 Ghz band, a 60 Ghz band, and/or any other mmWave band; and/or any other band, e.g., a 5G band, an S1G band, and/or any other band.

In some demonstrative aspects, radios 114, 173 and/or 144 may include, or may be associated with one or more, e.g., a plurality of, antennas.

In some demonstrative aspects, device 102 may include one or more, e.g., a plurality of, antennas 107, device 150 may include one or more, e.g., a plurality of, antennas 177, and/or device 140 may include one or more, e.g., a plurality of, antennas 147.

Antennas 107, 177 and/or 147 may include any type of antennas suitable for transmitting and/or receiving wireless communication signals, blocks, frames, transmission streams, packets, messages and/or data. For example, antennas 107, 177 and/or 147 may include any suitable configuration, structure and/or arrangement of one or more antenna elements, components, units, assemblies and/or arrays. In some aspects, antennas 107, 177 and/or 147 may implement transmit and receive functionalities using separate transmit and receive antenna elements. In some aspects, antennas 107, 177 and/or 147 may implement transmit and receive functionalities using common and/or integrated transmit/receive elements.

In some demonstrative aspects, device 102 may include a controller 124, device 150 may include a controller 174, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 150 and/or one or more other devices; controller 174 may be configured to perform, and/or to trigger, cause, instruct and/or control device 150 to perform, one or more communications, to generate and/or communicate one or more messages and/or transmissions, and/or to perform one or more functionalities, operations and/or procedures between devices 102, 140, 150 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 150 and/or one or more other devices, e.g., as described below.

In some demonstrative aspects, controllers 124, 174, and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124, 174 and/or 154, respectively. Additionally or alternatively, one or more functionalities of controllers 124, 174 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 174 may include circuitry and/or logic, for example, one or more processors including circuitry and/or logic, to cause, trigger and/or control a wireless device, e.g., device 150, and/or a wireless station, e.g., a wireless STA implemented by device 150, to perform one or more operations, communications and/or functionalities, e.g., as described herein. In one example, controller 174 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, at least part of the functionality of controller 154 may be implemented as part of one or more elements of radio 144, and/or at least part of the functionality of controller 174 may be implemented as part of one or more elements of radio 173.

In other aspects, the functionality of controller 124 may be implemented as part of any other element of device 102, the functionality of controller 174 may be implemented as part of any other element of device 150, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, device 150 may include a message processor 178 configured to generate, process and/or access one or messages communicated by device 150.

In one example, message processor 178 may be configured to generate one or more messages to be transmitted by device 150, and/or message processor 178 may be configured to access and/or to process one or more messages received by device 150, e.g., as described below.

In one example, message processor 178 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 178 may be configured to perform any other additional or alternative functionality and/or may include any other additional or alternative components to generate and/or process a message to be transmitted.

In some demonstrative aspects, message processors 128, 178 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128, 178 and/or 158, respectively. Additionally or alternatively, one or more functionalities of message processors 128, 178 and/or 158 may be implemented by logic, which may be executed by a machine and/or one or more processors, e.g., as described below.

In some demonstrative aspects, at least part of the functionality of message processor 128 may be implemented as part of radio 114, at least part of the functionality of message processor 174 may be implemented as part of radio 173, and/or at least part of the functionality of message processor 158 may be implemented as part of radio 144.

In some demonstrative aspects, at least part of the functionality of message processor 128 may be implemented as part of controller 124, at least part of the functionality of message processor 178 may be implemented as part of controller 174, and/or at least part of the functionality of message processor 158 may be implemented as part of controller 154.

In other aspects, the functionality of message processor 128 may be implemented as part of any other element of device 102, the functionality of message processor 178 may be implemented as part of any other element of device 150, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, at least part of the functionality of controller 174 and/or message processor 178 may be implemented by an integrated circuit, for example, a chip, e.g., a SoC. In one example, the chip or SoC may be configured to perform one or more functionalities of one or more radios 173. For example, the chip or SoC may include one or more elements of controller 174, one or more elements of message processor 178, and/or one or more elements of one or more radios 173. In one example, controller 174, message processor 178, and one or more radios 173 may be implemented as part of the chip or SoC.

In other aspects, controller 174, message processor 178 and/or one or more radios 173 may be implemented by one or more additional or alternative elements of device 150.

In some demonstrative aspects, device 102, device 150, and/or device 140 may include, operate as, perform the role of, and/or perform one or more functionalities of, one or more STAs. For example, device 102 may include at least one STA, device 150 may include at least one STA, and/or device 140 may include at least one STA.

In some demonstrative aspects, device 102, device 140, and/or device 150 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, device 150 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, device 102, device 140, and/or device 150 may include, operate as, perform the role of, and/or perform one or more functionalities of, one or more mmWave STAs, e.g., DMG STAs, EDMG STAs, and/or any other mmWave STA. For example, device 102 may include, operate as, perform the role of, and/or perform one or more functionalities of, one or more mmWave STAs, device 150 may include, operate as, perform the role of, and/or perform one or more functionalities of, one or more mmWave STAs, and/or device 140 may include, operate as, perform the role of, and/or perform one or more functionalities of, one or more mmWave STAs.

In other aspects, devices 102, 140, and/or 150 may include, operate as, perform the role of, and/or perform one or more functionalities of, any other wireless device and/or station, e.g., a WLAN STA, a WiFi STA, and the like.

In some demonstrative aspects, device 102, device 140, and/or device 150 may be configured to operate as, perform the role of, and/or perform one or more functionalities of, an access point (AP), e.g., an EHT AP STA.

In some demonstrative aspects, device 102, device 140, and/or device 150 may be configured to operate as, perform the role of, and/or perform one or more functionalities of, a non-AP STA, e.g., an EHT non-AP STA.

In other aspects, device 102, device 140, and/or device 150 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 150 may be configured to communicate in an EHT network, and/or any other network.

In some demonstrative aspects, devices 102, 140, and/or 150 may be configured to operate in accordance with one or more Specifications, for example, including one or more IEEE 802.11 Specifications, e.g., an IEEE 802.11-2020 Specification, an IEEE 802.11be Specification, an IEEE 802.11ay Specification and/or any other specification and/or protocol.

In some demonstrative aspects, device 102, device 140, and/or device 150 may include, operate as, perform a role of, and/or perform the functionality of, one or more multi-link logical entities, e.g., as described below.

In other aspect, device 102, device 140, and/or device 150 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102, device 140, and/or device 150 may include, operate as, perform a role of, and/or perform the functionality of, a Multi-Link Device (MLD). For example, device 102 may include, operate as, perform a role of, and/or perform the functionality of, at least one MLD, device 150 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity and has more than one affiliated STA and has a single MAC service access point (SAP) to LLC, which includes one MAC data service. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 150 may be configured to operate as, perform the role of, and/or perform one or more functionalities of, an AP MLD.

In some demonstrative aspects, device 102, device 140, and/or device 150 may be configured to operate as, perform the role of, and/or perform one or more functionalities of, a non-AP MLD.

In other aspects, device 102, device 140, and/or device 150 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to control, perform and/or to trigger, cause, instruct and/or control device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141. In some aspects, as shown in FIG. 1, AP MLD 131 may include four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, a mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 Ghz band, as described below.

In some demonstrative aspects, for example, the one or more radios 114 may include, for example, a radio for communication by AP STA 137 over a second wireless communication frequency channel and/or frequency band, e.g., a 5 Ghz band, as described below.

In some demonstrative aspects, for example, the one or more radios 114 may include, for example, a radio for communication by AP STA 139 over a third wireless communication frequency channel and/or frequency band, e.g., a 6 Ghz band, as described below.

In some demonstrative aspects, for example, the one or more radios 114 may include, for example, a radio for communication by mmWave STA 141 over a fourth wireless communication frequency channel and/or frequency band, e.g., an mmWave band, for example, a wireless communication band above 45 Ghz, for example, a 60 GHz band or any other mmWave band, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects controller 124 may be configured to control, perform and/or to trigger, cause, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 174 may be configured to control, perform and/or to trigger, cause, instruct and/or control device 150 to operate as, perform a role of, and/or perform one or more operations and/or functionalities of, an AP MLD 179 including a plurality of STAs, e.g., including an AP STA 171.

In one example, one or more APs of AP MLD 179 may operate as, perform a role of, and/or perform one or more operations and/or functionalities of, an EHT AP STA. In other aspects, one or more APs of AP MLD 179 may perform any other additional or alternative functionality.

In other aspects controller 174 may be configured to control, perform and/or to trigger, cause, instruct and/or control device 150 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to control, perform and/or to trigger, cause, instruct and/or control device 140 to operate as, perform a role of, and/or perform one or more operations and/or functionalities of, an MLD 151 including a plurality of STAs 153, e.g., including a STA 155, a STA 157, a STA 159, and/or a STA 161. In some aspects, as shown in FIG. 1, MLD 151 may include four STAs. In other aspects, MLD 151 may include any other number of STAs.

In one example, STA 155, STA 157, STA 159, and/or STA 161 may operate as, perform a role of, and/or perform one or more operations and/or functionalities of, an EHT STA. In other aspects, STA 155, STA 157, STA 159, and/or STA 161 may perform any other additional or alternative functionality.

In some demonstrative aspects, STA 161 may be configured to operate as, perform a role of, and/or perform one or more operations and/or functionalities of, an mmWave STA, e.g., as described below. For example, the mmWave STA 161 may be configured to operate as, perform a role of, and/or perform one or more operations and/or functionalities of, a non-AP mmWave STA, e.g., as described below.

In some demonstrative aspects, for example, the one or more radios 144 may include, for example, a radio for communication by STA 155 over a first wireless communication frequency channel and/or frequency band, e.g., a 2.4 Ghz band, as described below.

In some demonstrative aspects, for example, the one or more radios 144 may include, for example, a radio for communication by STA 157 over a second wireless communication frequency channel and/or frequency band, e.g., a 5 Ghz band, as described below.

In some demonstrative aspects, for example, the one or more radios 144 may include, for example, a radio for communication by STA 159 over a third wireless communication frequency channel and/or frequency band, e.g., a 6 Ghz band, as described below.

In some demonstrative aspects, for example, the one or more radios 144 may include, for example, a radio for communication by mmWave STA 161 over a fourth wireless communication frequency channel and/or frequency band, e.g., a mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to control, perform and/or to trigger, cause, instruct and/or control MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to control, perform and/or to trigger, cause, instruct and/or control MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects controller 154 may be configured to control, perform and/or to trigger, cause, instruct and/or control device 140 to operate as, perform a role of, and/or perform one or more operations and/or functionalities of, any other additional or alternative entity and/or STA, e.g., a single STA, multiple STAs, and/or a non-MLD entity.

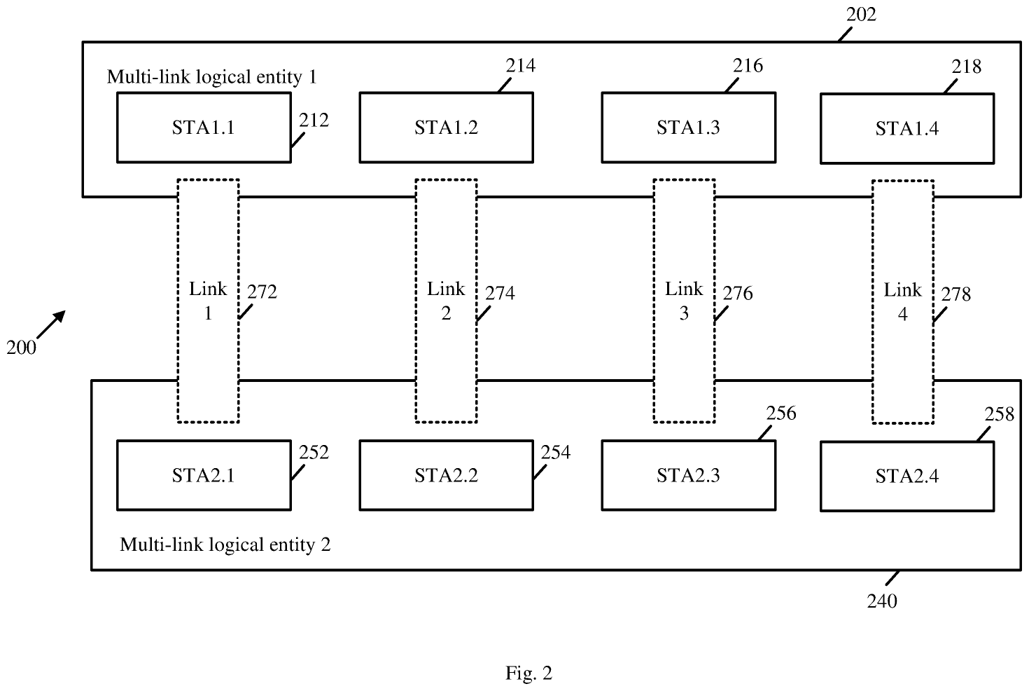

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations of, one or more functionalities of, the role of, and/or the functionality of, multi-link logical entity 202. In another example, AP MLD 179 (FIG. 1) may perform one or more operations of, one or more functionalities of, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations of, one or more functionalities of, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

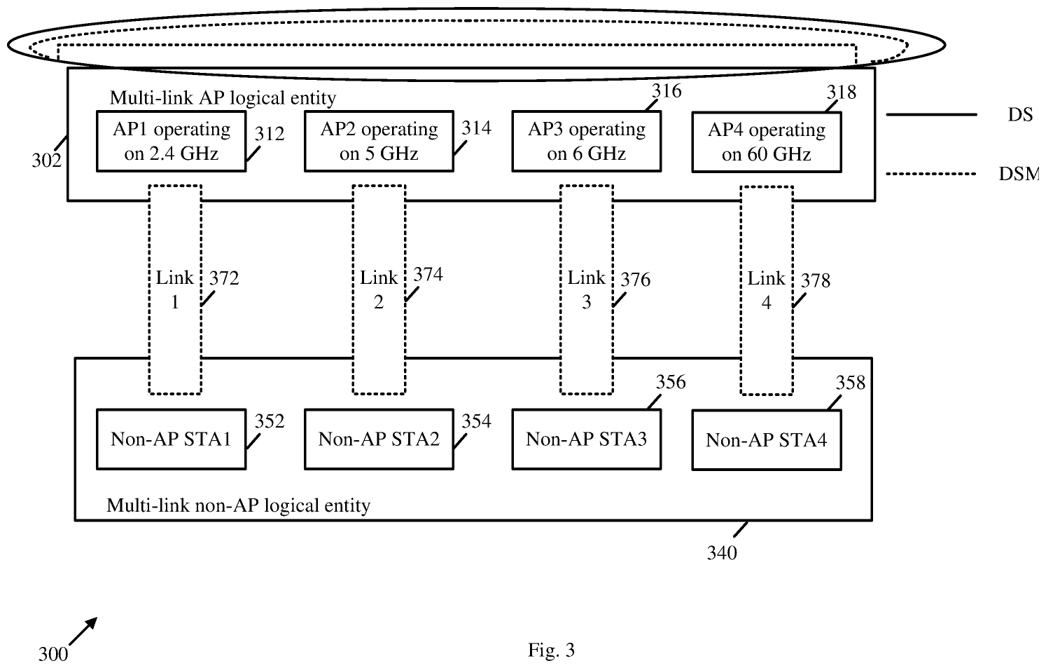

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, an AP STA 316, and an mmWave STA 318. In one example, AP MLD 131 (FIG. 1) may perform one or more operations of, one or more functionalities of, the role of, and/or the functionality of, multi-link AP logical entity 302. In another example, AP MLD 179 (FIG. 1) may perform one or more operations of, one or more functionalities of, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations of, one or more functionalities of, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 Ghz frequency band, AP STA 314 may be configured to communicate over a 5 Ghz frequency band, AP STA 316 may be configured to communicate over a 6 Ghz frequency band, and/or mmWave STA 318 may be configured to communicate over a mmWave frequency band. In other aspects, AP STA 312, AP STA 314, AP STA 316, and/or mmWave STA 318 may be configured to communicate over any other additional or alternative wireless communication frequency bands.

Referring back to FIG. 1, in some demonstrative aspects, devices 102, 140 and/or 150 may be configured to perform one or more operations of a Fast Basis Service Set (BSS) Transition (FT), for example, to allow a station, for example, an FT Originator (FTO) STA, to move from a first AP STA (also referred to as the “current AP” or “source AP”) to a second AP STA (also referred to as the “target AP”), e.g., as described below.

In one example, device 140 may be configured to include, operate as, perform the role of, and/or perform the functionality of the FTO, device 102 may be configured to include, operate as, perform the role of, and/or perform the functionality of the source AP, and/or device 150 may be configured to include, operate as, perform the role of, and/or perform the functionality of the target AP, e.g., as described below.

In some demonstrative aspects, the FT may allow, for example, to reduce a time that connectivity is lost between a STA and a Distribution System (DS) during a BSS transition.

In some demonstrative aspects, one or more FT protocols may be applied, for example, to STA transitions between APs, e.g., within a same mobility domain, which is within a same Extended Service Set (ESS).

In one example, an FT protocol may support, for example, a STA movement from one BSS in an ESS to another BSS within the ESS, for example, a change of association by a STA that is from one BSS in an ESS to another BSS within the same ESS. According to this example, the FT may minimize an amount of time that data connectivity is lost between the STA and the DS.

In some demonstrative aspects, the DS may include, for example, a system to interconnect a set of BSSs and integrated local area networks (LANs) to create an ESS. In other aspects, the DS may include any other additional or alternative elements.

In some demonstrative aspects, an FTO may move from its current AP to a target AP, e.g., utilizing one or more FT protocols, for example, by performing one or more message exchanges according to an “over the DS” mechanism.

For example, according to the over-the-DS mechanism, the FTO may communicate with the target AP via the current AP. For example, the communication between the FTO and the target AP may be carried in FT action frames, which may be communicated between the FTO and the current AP. For example, communication between the current AP and target AP may be via an encapsulation of FT Action Frames, for example, using Remote Request or Remote Response frames. The over-the-DS mechanism may utilize any additional or alternative messages, frames and/or mechanisms.

In some demonstrative aspects, the one or more FT protocols may include, for example, an FT resource request protocol, which may allow, for example, an FTO to request resources, e.g., prior to reassociation.

In some demonstrative aspects, device 102, device 140, and/or device 150 may be configured to support a technical solution for wireless roaming of a STA, e.g., a STA implemented by device 140, between APs, for example, between a first AP, e.g., between an AP implemented by device 102, and a second AP, e.g., an AP implemented by device 150.

In some demonstrative aspects, device 102, device 140, and/or device 150 may be configured to support a technical solution of wireless roaming for Time-Sensitive Networking (TSN) and/or Real-Time applications (RTA), which may require high reliability with low bounded latency and/or jitter.

For example, it may be challenging to support TSN and/or RTA via wireless communication, e.g., due to the stochastic nature of a wireless channel.

For example, it may be even more challenging to support TSN and/or RTA via wireless communication of mobile devices, e.g., as the wireless channel may change in time.

For example, a procedure for wireless, e.g., WiFi, roaming within a wireless communication network, e.g., an ESS may include a plurality of stages, for example, a periodic channel scanning, decision making about when and which AP to roam to, an FT procedure, and/or packet forwarding from a source AP to a target AP, which may be implementation specific. Accordingly, there may be some packet loss and/or delay, for example, due to a re-routing process for routing a STA from the source AP to the target AP.

For example, during a roaming procedure for wireless roaming of a STA between a source AP and a target AP, a routing table may be updated in a DS between the source AP and the destination AP, for example, starting from the beginning of the roaming procedure until the time when the STA is associated with the target AP. However, there may be a disconnection time period between the STA and DS, which may lead to a delay, e.g., even a large delay, and/or packet loss. This resulting delay and/or packet loss may be unacceptable in some implementations, for example, for ultra-reliability and ultra-low latency applications.

In some demonstrative aspects, device 102, device 140, and/or device 150 may be configured to implement a multi-band operation mechanism, which may be configured, for example, according to a general framework that may capture one or more use cases for multi-band operation, e.g., including STA seamless and/or lossless transition between links/bands, STA operation on multiple links/bands with different Traffic Identifiers (TIDs) on different links/bands, and/or STA operation on multiple links/bands with aggregation for the same TID. for multi-band operation. For example, the multi-band operation mechanism may be implemented to support these use cases, for example, in implementations of a STA as a single radio device or ad a multi-radio device, and/or in implementations of APs having the same or different MAC addresses, and/or APs being collocated or non-collocated.

In some demonstrative aspects, device 102, device 140, and/or device 150 may be configured to implement an FT mechanism for MLD operation, e.g., as described below.

In some demonstrative aspects, there may be a need to provide a technical solution to address one or more issues of FT for MLDs.

For example, a multi-link association may be performed through a single link between a STA MLD and an AP MLS, and/or the STA MLD may have a multi-link connection with a current AP MLD. For example, the MLD STA may follow an FT protocol to roam from the current AP MLD to a target AP MLD. However, the STA MLD may disconnect with the current AP MLD over all the links, for example, once the STA MLD completes the FT protocol with the target AP MLD over one of the links. As a result, the STA MLD may face a technical problem of packet loss and/or delay, for example, during the roaming period, e.g., similar to a single link case.

In some demonstrative aspects, device 102, device 140, and/or device 150 may be configured to implement an FT mechanism for MLD operation, which may be configured to provide a technical solution to support a “zero roaming effect” capability for STA mobility, for example, by leveraging multi-AP coordination capability, e.g., as described below.

In some demonstrative aspects, for example, in some use cases, implementations and/or scenarios, there may be one or more disadvantages and/or inefficiencies in implementing a layer-3 dual connectivity mechanism to support FT. For example, a layer-3 dual connectivity mechanism may utilize a virtual NIC mechanism, where a STA may have separate links to the DS, for example, with different MAC addresses. For example, integration of these multi-links may be performed in a higher layer. However, it may be inefficient to use the higher layer for the multi-link integration, e.g., compared to a layer-2 multi-link, for example, in terms of traffic scheduling and/or traffic steering.

In some demonstrative aspects, device 102, device 140, and/or device 150 may be configured to implement an FT mechanism for MLD operation, which may be configured to provide a technical solution to support an “instantaneous roaming” capability for STA mobility, for example, by leveraging on-relay-tunneling, e.g., as described below.

In some demonstrative aspects, device 102, device 140, and/or device 150 may be configured to implement an FT mechanism for MLD operation, which may be configured to provide a technical solution to support a STA MLD (also referred to as “non-AP MLD”) to set up association with a target AP MLD, for example, through a current AP MLD, e.g., as described below.

In some demonstrative aspects, device 102, device 140, and/or device 150 may be configured to implement an FT mechanism for MLD operation, which may be configured to provide a technical solution to support the current AP to forward an association (reassociation) request management frame, which may be received from the STA MLD, to the target AP MLD, e.g., as described below.

In some demonstrative aspects, the current AP may be configured to forward the association (reassociation) request management frame to the target AP MLD, for example, over an associated link to the target AP MLD.

In other aspects, the current AP may be configured to forward the association (reassociation) request management frame to the target AP MLD via any other link or connection, for example, over another link, a control plane over the air, and/or connected ethernet cable through a backhaul.

In some demonstrative aspects, device 102, device 140, and/or device 150 may be configured to implement an FT mechanism for MLD operation, which may be configured to support the current AP to provide a copy of data frames for the STA MLD to the target AP MLD, e.g., as descried below.

In some demonstrative aspects, the current AP may provide the copy of data frames for the STA MLD to the target AP MLD, for example, together with the association management, or at a later stage, for example, based on the when the STA MLD decides to switch to the target AP MLD.

In some demonstrative aspects, the FT mechanism for MLD operation may be configured to support the STA MLD to switch the association with the target AP MLD, for example, substantially instantaneously, e.g., as described below.

In some demonstrative aspects, the FT mechanism for MLD operation may be configured provide a technical solution to avoid the packet loss and/or extra delay for packet that may still be stored at the current AP, for example, after the STA MLD has switched to the target AP MLD, e.g., as described below.

In some demonstrative aspects, device 102, device 140, and/or device 150 may be configured to implement an FT mechanism for MLD operation, which may be configured to provide a technical solution to support coordination among multi-connected APs, for example during the FT procedure, e.g., as described below.

In some demonstrative aspects, device 102, device 140, and/or device 150 may be configured to implement an FT mechanism for MLD operation, which may be configured to provide a technical solution to support ultra-reliable time-sensitive applications with flexibility and/or mobility, for example, for many time-critical industrial systems, e.g., including mobile Robot systems, Automatic Guided vehicle (AGV) systems, controllers, or the like.

In some demonstrative aspects, controller 154 may be configured to control, trigger, cause, and/or instruct a STA implemented by device 140, e.g., STA 155, to transmit an FT request to a target AP via a current AP with which the STA is associated, e.g., as described below.

In some demonstrative aspects, the FT request may be configured to request an FT from the current AP to the target AP. For example, the current AP may include an AP implemented by device 102, and/or the target AP may include an AP implemented by device 150, e.g., as described below. In other aspects, the current AP may include an AP implemented by device 150 and/or any other AP, and/or the target AP may include an AP implemented by device 102 and/or any other AP.

In some demonstrative aspects, the FT may include an FT over a DS between the current AP and the target AP, e.g., as described below. In other aspects, the FT may include any other type of FT.

In some demonstrative aspects, controller 154 may be configured to control, trigger, cause, and/or instruct the STA implemented by device 140, e.g., STA 155, to process an FT response from the target AP, for example, after the FT request, e.g., as described below.

In some demonstrative aspects, the FT response may be received by the STA via the current AP, e.g., as described below.

In some demonstrative aspects, controller 154 may be configured to control, trigger, cause, and/or instruct the STA implemented by device 140, e.g., STA 155, to transmit a reassociation request to the target AP via the current AP, for example, after the FT response, e.g., as described below.

In some demonstrative aspects, the reassociation request may be configured to request to associate between the STA and the target AP, e.g., as described below.

In some demonstrative aspects, controller 154 may be configured to control, trigger, cause, and/or instruct the STA implemented by device 140, e.g., STA 155, to process a reassociation response from the target AP, for example, after the reassociation request, e.g., as described below.

In some demonstrative aspects, the reassociation response may be received by the STA via the current AP, e.g., as described below.

In some demonstrative aspects, the reassociation request and/or the reassociation response may include tunneled messages according to a tunneling protocol between the STA and the target AP via the current AP, e.g., as described below.

In other aspects, the reassociation request and/or the reassociation response may be configured and/or communicated as any other type of message.

In some demonstrative aspects, controller 154 may be configured to control, trigger, cause, and/or instruct the STA implemented by device 140, e.g., STA 155, to switch the STA from the current AP to the target AP, for example, for communication via an associated session between the STA and the target AP, e.g., as described below.

In some demonstrative aspects, controller 154 may be configured to control, trigger, cause, and/or instruct the STA implemented by device 140, e.g., STA 155, to process one or more buffered data packets received from the target AP via the associated session between the STA and the target AP, e.g., as described below.

In some demonstrative aspects, the buffered data packets received from the target AP may include data buffered by the current AP, for example, prior to the STA switching from the current AP to the target AP, e.g., as described below.

In some demonstrative aspects, controller 154 may be configured to control, trigger, cause, and/or instruct the STA implemented by device 140, e.g., STA 155, to transmit to the current AP a message including an indication of a criterion to send the buffered data packets, e.g., which include the buffered data for the STA, to the target AP, e.g., as described below.

In some demonstrative aspects, the criterion may include an amount of the buffered data packets to be sent to the target AP, e.g., as described below.

In other aspects, any other criterion and/or parameters may be implemented for configuring the current AP to send the buffered data packets of the STA to the target AP.

In some demonstrative aspects, controller 154 may be configured to control, trigger, cause, and/or instruct the STA implemented by device 140, e.g., STA 155, to trigger transmission of the reassociation request to the target AP based on at least one criterion, e.g., as described below.

In some demonstrative aspects, controller 154 may be configured to control, trigger, cause, and/or instruct the STA implemented by device 140, e.g., STA 155, to trigger transmission of the reassociation request to the target AP, for example, based on a channel condition of a wireless communication channel between the STA and the current AP, e.g., as described below.

In some demonstrative aspects, controller 154 may be configured to control, trigger, cause, and/or instruct the STA implemented by device 140, e.g., STA 155, to trigger transmission of the reassociation request to the target AP based on any other additional or alternative criterion and/or parameter.

In some demonstrative aspects, controller 154 may be configured to control, trigger, cause, and/or instruct the STA implemented by device 140, e.g., STA 155, to transmit an AP switch request to the target AP, for example, after the reassociation response, e.g., as described below.

In some demonstrative aspects, the AP switch request may be configured to request to switch the STA to the target AP for communication via the associated session between the STA and the target AP, e.g., as described below.

In some demonstrative aspects, controller 154 may be configured to control, trigger, cause, and/or instruct the STA implemented by device 140, e.g., STA 155, to process an AP switch response from the target AP, e.g., as described below.

In some demonstrative aspects, the AP switch response may be configured to confirm the request to switch the STA to the target AP for communication via the associated session between the STA and the target AP, e.g., as described below.

In some demonstrative aspects, controller 154 may be configured to control, trigger, cause, and/or instruct the STA implemented by device 140, e.g., STA 155, to identify a capability of the current AP to support communication of the reassociation request and the reassociation response with the target AP, e.g., as described below.

In some demonstrative aspects, controller 154 may be configured to control, trigger, cause, and/or instruct the STA implemented by device 140, e.g., STA 155, to identify, for example, based on a capability indication in a message from the current AP, the capability of the current AP to support communication of the reassociation request and the reassociation response with the target AP, e.g., as described below.

In some demonstrative aspects, the message to indicate the capability of the current AP to support communication of the reassociation request and the reassociation response with the target AP may include, for example, a beacon from the current AP, e.g., as described below.

In some demonstrative aspects, the message to indicate the capability of the current AP to support communication of the reassociation request and the reassociation response with the target AP may include, for example, an association frame received from the current AP, for example, during association with the current AP, e.g., as described below.

In other aspects, any other additional or alternative type of message may be utilized to indicate the capability of the current AP to support communication of the reassociation request and the reassociation response with the target AP.

In some demonstrative aspects, controller 154 may be configured to control, trigger, cause, and/or instruct the STA implemented by device 140, e.g., STA 155, to identify a capability indication in a neighbor report element from the current AP, a capability of the target AP to support communication of the reassociation request and the reassociation response via the current AP, e.g., as described below.

In some demonstrative aspects, controller 154 may be configured to control, trigger, cause, and/or instruct the STA implemented by device 140, e.g., STA 155, to identify, for example, based on a capability indication in a neighbor report element from the current AP, the capability of the target AP to support communication of the reassociation request and the reassociation response via the current AP, e.g., as described below.

In other aspects, any other additional or alternative type of message may be utilized to indicate the capability of the target AP to support communication of the reassociation request and the reassociation response via the current AP.

In some demonstrative aspects, controller 154 may be configured to control, trigger, cause, and/or instruct the STA implemented by device 140, e.g., STA 155, to communicate an agreement setup message with the target AP via the current AP, for example, prior to the STA switching from the current AP to the target AP, e.g., as described below.

In some demonstrative aspects, the agreement setup message may be configured to setup an agreement for communication via the associated session between the STA and the target AP, e.g., as described below.

In some demonstrative aspects, the agreement message may include an Add Block Acknowledgement (ADDBA) message to setup an ADDBA agreement, e.g., as described below.

In some demonstrative aspects, the agreement message may include a Target Wake Time (TWT) message to setup a TWT agreement, e.g., as described below.

In other aspects, the agreement message may include any other additional or alternative type of message to setup any other additional or alternative agreement.

In some demonstrative aspects, controller 124 may be configured to control, trigger, cause, and/or instruct an AP implemented by device 102, e.g., AP 135, to act as a current AP of an FT. For example, the FT may be performed to switch the STA implemented by device 140 from the current AP implemented by device 102 to the target AP implemented by device 150, e.g., as described below.

In some demonstrative aspects, controller 124 may be configured to control, trigger, cause, and/or instruct the AP implemented by device 102, e.g., AP 135, to communicate via the current AP an FT request between a STA, which is associated with the current AP and a target AP, e.g., as described below.

In some demonstrative aspects, the FT request may be communicated from the STA, e.g., the STA implemented by device 140, to the target AP, e.g., the AP implemented by device 150.

In some demonstrative aspects, the FT request may be configured to request the FT of the STA, e.g., the STA implemented by device 140, from the current AP, e.g., the AP implemented by device 102, to the target AP, e.g., the AP implemented by device 150.

In some demonstrative aspects, the FT may include an FT over a DS between the current AP and the target AP, e.g., as described below. In other aspects, the FT may include any other type of FT.

In some demonstrative aspects, controller 124 may be configured to control, trigger, cause, and/or instruct the AP implemented by device 102, e.g., AP 135, to communicate via the current AP an FT response between the target AP and the STA, for example, after the FT request, e.g., as described below.

In some demonstrative aspects, the FT response may be communicated from the target AP, e.g., the AP implemented by device 150, to the STA, e.g., the STA implemented by device 140.

In some demonstrative aspects, controller 124 may be configured to control, trigger, cause, and/or instruct the AP implemented by device 102, e.g., AP 135, to communicate via the current AP a reassociation request between the STA and the target AP, for example, after the FT response, e.g., as described below.

In some demonstrative aspects, the reassociation request may be communicated from the STA, e.g., the STA implemented by device 140, to the target AP, e.g., the AP implemented by device 150.

In some demonstrative aspects, the reassociation request may be configured to request to associate between the STA and the target AP, e.g., as described below.

In some demonstrative aspects, controller 124 may be configured to control, trigger, cause, and/or instruct the AP implemented by device 102, e.g., AP 135, to communicate via the current AP a reassociation response between the target AP and the STA, for example, after the reassociation request, e.g., as described below.

In some demonstrative aspects, the reassociation response may be communicated from the target AP, e.g., the AP implemented by device 150, to the STA, e.g., the STA implemented by device 140.

In some demonstrative aspects, the reassociation request and/or the reassociation response may include tunneled messages according to a tunneling protocol between the STA and the target AP via the current AP, e.g., as described below.

In other aspects, the reassociation request and/or the reassociation response may be configured and/or communicated as any other type of message.

In some demonstrative aspects, controller 124 may be configured to control, trigger, cause, and/or instruct the AP implemented by device 102, e.g., AP 135, to transmit one or more buffered data packets to the target AP, e.g., as described below.

In some demonstrative aspects, the buffered data packets may include data for the STA, e.g., the STA implemented by device 140, which may be buffered by the current AP, for example, prior to the STA switching from the current AP to the target AP, e.g., as described below.

In some demonstrative aspects, controller 124 may be configured to control, trigger, cause, and/or instruct the AP implemented by device 102, e.g., AP 135, to identify, based on a message from the STA, a criterion to send the buffered data packets to the target AP, e.g., as described below.

In some demonstrative aspects, the criterion may include an amount of the buffered data packets to be sent to the target AP, e.g., as described below. In other aspects, any other additional or alternative criterion and/or parameter may be implemented by the current AP to send the buffered data packets to the target AP.

In some demonstrative aspects, controller 124 may be configured to control, trigger, cause, and/or instruct the AP implemented by device 102, e.g., AP 135, to transmit a capability indication in a message from the current AP, for example, to indicate a capability of the current AP to support communication of the reassociation request and the reassociation response with the target AP, e.g., as described below.

In some demonstrative aspects, controller 124 may be configured to control, trigger, cause, and/or instruct the AP implemented by device 102, e.g., AP 135, to transmit a beacon from the current AP to indicate the capability of the current AP to support communication of the reassociation request and the reassociation response with the target AP, e.g., as described below.

In some demonstrative aspects, controller 124 may be configured to control, trigger, cause, and/or instruct the AP implemented by device 102, e.g., AP 135, to transmit an association frame to the STA, for example, during association with the STA, for example, to indicate the capability of the current AP to support communication of the reassociation request and the reassociation response with the target AP, e.g., as described below.

In other aspects, controller 124 may be configured to control, trigger, cause, and/or instruct the AP implemented by device 102, e.g., AP 135, to transmit any other type of message including the indication of the capability of the current AP to support communication of the reassociation request and the reassociation response with the target AP.

In some demonstrative aspects, controller 124 may be configured to control, trigger, cause, and/or instruct the AP implemented by device 102, e.g., AP 135, to transmit a message including an indication of a capability of the target AP to support communication of the reassociation request and the reassociation response via the current AP, e.g., as described below.

In some demonstrative aspects, controller 124 may be configured to control, trigger, cause, and/or instruct the AP implemented by device 102, e.g., AP 135, to transmit a neighbor report element corresponding to the target AP. For example, the neighbor report element may include the indication of the capability of the target AP to support communication of the reassociation request and the reassociation response via the current AP, e.g., as described below.

In other aspects, controller 124 may be configured to control, trigger, cause, and/or instruct the AP implemented by device 102, e.g., AP 135, to transmit any other type of message including the indication of the capability of the target AP to support communication of the reassociation request and the reassociation response via the current AP.

In some demonstrative aspects, controller 124 may be configured to control, trigger, cause, and/or instruct the AP implemented by device 102, e.g., AP 135, to communicate an agreement setup message between the STA and the target AP via the current AP, for example, prior to the STA switching from the current AP to the target AP, e.g., as described below.

In some demonstrative aspects, the agreement setup message may be configured to setup an agreement for communication via an associated session between the STA and the target AP, e.g., as described below.

In some demonstrative aspects, the agreement message may include an ADDBA message to setup an ADDBA agreement, e.g., as described below.

In some demonstrative aspects, the agreement message may include a TWT message to setup a TWT agreement, e.g., as described below.

In other aspects, the agreement message may include any other additional or alternative type of message to setup any other additional or alternative agreement.

In some demonstrative aspects, controller 174 may be configured to control, trigger, cause, and/or instruct an AP implemented by device 150, e.g., AP 171, to act as a target AP of an FT. For example, the FT may be performed to switch the STA implemented by device 140 from the current AP implemented by device 102 to the target AP implemented by device 150, e.g., as described below.

In some demonstrative aspects, the FT may include an FT over a DS between the current AP and the target AP, e.g., as described below. In other aspects, the FT may include any other type of FT.

In some demonstrative aspects, controller 174 may be configured to control, trigger, cause, and/or instruct the AP implemented by device 150, e.g., AP 171, to process an FT request from a STA, e.g., the STA implemented by device 140, associated with a current AP, e.g., the AP implemented by device 102.

In some demonstrative aspects, the FT request may be received from the STA, e.g., the STA implemented by device 102, via the current AP, e.g., the AP implemented by device 140.

In some demonstrative aspects, the FT request may be configured to request the FT from the current AP, e.g., the AP implemented by device 102 to the AP implemented by device 150.

In some demonstrative aspects, controller 174 may be configured to control, trigger, cause, and/or instruct the AP implemented by device 150, e.g., AP 171, to transmit an FT response to the STA via the current AP, for example, after the FT request, e.g., as described below.

In some demonstrative aspects, controller 174 may be configured to control, trigger, cause, and/or instruct the AP implemented by device 150, e.g., AP 171, to process a reassociation request from the STA, e.g., as described below.

In some demonstrative aspects, the reassociation request may be received from the STA, e.g., the STA implemented by device 140, via the current AP, e.g., the AP implemented by device 102, for example, after the FT response, e.g., as described below.

In some demonstrative aspects, the reassociation request may be configured to request to associate between the STA, e.g., the STA implemented by device 140, and the target AP, e.g., the AP implemented by device 150.

In some demonstrative aspects, controller 174 may be configured to control, trigger, cause, and/or instruct the AP implemented by device 150, e.g., AP 171, to transmit a reassociation response to the STA via the current AP, for example, after the reassociation request, e.g., as described below.

In some demonstrative aspects, the reassociation request and/or the reassociation response may include tunneled messages according to a tunneling protocol between the STA and the target AP via the current AP, e.g., as described below.

In some demonstrative aspects, controller 174 may be configured to control, trigger, cause, and/or instruct the AP implemented by device 150, e.g., AP 171, to communicate with the STA via an associated session between the STA and the target AP, e.g., as described below.

In some demonstrative aspects, controller 174 may be configured to control, trigger, cause, and/or instruct the AP implemented by device 150, e.g., AP 171, to process one or more buffered data packets received from the current AP, e.g., as described below.

In some demonstrative aspects, the buffered data packets may include data packets buffered by the current AP, e.g., the AP implemented by device 102, for example, prior to the STA switching from the current AP to the target AP, e.g., as described below.

In some demonstrative aspects, controller 174 may be configured to control, trigger, cause, and/or instruct the AP implemented by device 150, e.g., AP 171, to transmit the buffered data packets to the STA, for example, via the associated session between the STA and the target AP implemented by device 150, e.g., as described below.

In some demonstrative aspects, controller 174 may be configured to control, trigger, cause, and/or instruct the AP implemented by device 150, e.g., AP 171, to process an AP switch request from the STA. For example, the switch request from the STA may be received at the target AP after the reassociation response transmitted from the target AP implemented by device 150 to the STA implemented by device 140 via the current AP implemented by device 102, e.g., as described below.

In some demonstrative aspects, the AP switch request may be configured to request to switch the STA to the target AP for communication via the associated session between the STA and the target AP, e.g., as described below.

In some demonstrative aspects, controller 174 may be configured to control, trigger, cause, and/or instruct the AP implemented by device 150, e.g., AP 171, to transmit an AP switch response to the STA, for example, to confirm the request to switch the STA to the target AP for communication via the associated session between the STA and the target AP, e.g., as described below.

In some demonstrative aspects, controller 174 may be configured to control, trigger, cause, and/or instruct the AP implemented by device 150, e.g., AP 171, to communicate an agreement setup message with the STA via the current AP, for example, prior to the STA switching from the current AP to the target AP implemented by device 150, e.g., as described below.

In some demonstrative aspects, the agreement setup message may be configured to setup an agreement for communication via the associated session between the STA and the target AP implemented by device 150, e.g., as described below.

In some demonstrative aspects, the agreement message may include an ADDBA message to setup an ADDBA agreement, e.g., as described below.

In some demonstrative aspects, the agreement message may include a TWT message to setup a TWT agreement, e.g., as described below.

In other aspects, the agreement message may include any other additional or alternative type of message to setup any other additional or alternative agreement.

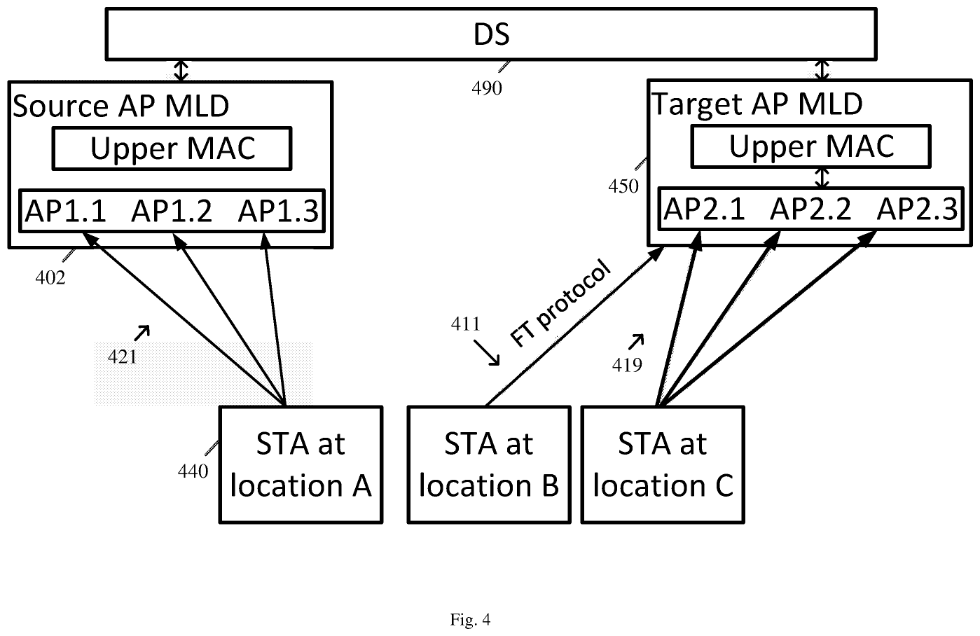

Reference is made to FIG. 4, which schematically illustrates an MLD FT scheme, which may be implemented in accordance with some demonstrative aspects.

In some demonstrative aspects, as shown in FIG. 4, a STA 440, e.g., a STA MLD, may be associated with a current AP MLD 402, for example, when the STA 440 is at a first location (location A). In one example, device 140 (FIG. 1) may perform one or more operations of, one or more functionalities of, the role of, and/or the functionality of, STA 440. In one example, device 102 (FIG. 1) may perform one or more operations of, one or more functionalities of, the role of, and/or the functionality of, AP MLD 402.

In some demonstrative aspects, as shown in FIG. 4, the STA 440 may have a multi-link connection 421 with the current AP MLD 402, for example, including three links with three respective APs of the AP MLD 402.

In some demonstrative aspects, as shown in FIG. 4, the STA 440 may move away from the AP MLD 402, for example, towards a second location (location B).

In some demonstrative aspects, as shown in FIG. 4, the STA 440 may perform an FT protocol 411 to switch the STA 440 from the current AP MLD 402 to a target AP MLD 450. In one example, device 150 (FIG. 1) may perform one or more operations of, one or more functionalities of, the role of, and/or the functionality of, AP MLD 450.

In some demonstrative aspects, the FT protocol 411 may include an FT over a DS 490 between the current AP MLD 402 and the target AP MLD 450.

In some demonstrative aspects, as shown in FIG. 4, the STA 440 may switch from the current AP MLD 402 to the target AP MLD 450 for communication via an associated session between the STA 440 and the target AP MLD 450, for example, when the STA 440 is at a third location (location C).

In some demonstrative aspects, as shown in FIG. 4, the STA 440 may have a multi-link connection 419 with the target AP MLD 450, for example, including three links with three respective APs of the AP MLD 450.

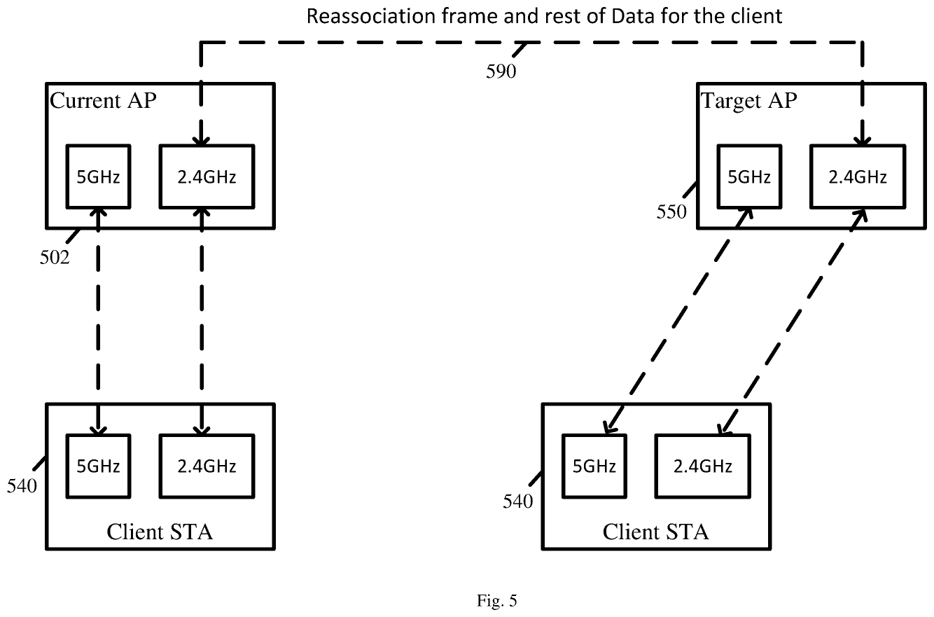

Reference is made to FIG. 5, which schematically illustrates a FT utilizing a backhaul connection, in accordance with some demonstrative aspects.

In some demonstrative aspects, as shown in FIG. 5, a STA 540, e.g., a STA MLD, may be associated with a current AP MLD 502, for example, when the STA 540 is at a first location. In one example, device 140 (FIG. 1) may perform one or more operations of, one or more functionalities of, the role of, and/or the functionality of, STA 540. In one example, device 102 (FIG. 1) may perform one or more operations of, one or more functionalities of, the role of, and/or the functionality of, AP MLD 502.

In some demonstrative aspects, as shown in FIG. 5, the STA 540 may have a multi-link connection with the current AP MLD 402, for example, including a first link between a 2.4 GHz STA of the STA 540 and a 2.4 GHz AP of the AP MLD 502, and a second link between a 5 GHz STA of the STA 540 and a 5 GHz AP of the AP MLD 502.

In some demonstrative aspects, as shown in FIG. 5, the STA 540 may move away from the AP MLD 502, for example, towards a target AP MLD 550.

In some demonstrative aspects, as shown in FIG. 5, the STA 540 may perform an FT protocol to switch the STA 540 from the current AP MLD 502 to the target AP MLD 550. In one example, device 150 (FIG. 1) may perform one or more operations of, one or more functionalities of, the role of, and/or the functionality of, AP MLD 550.

In some demonstrative aspects, the FT protocol may include an FT over a DS between the current AP MLD 502 and the target AP MLD 550.

In some demonstrative aspects, the STA 540, the current AP MLD 502 and/or the target AP MLD 550 may be configured to support an FT protocol configured to support setting up an association between the STA 540 and the target AP MLD 550, for example, via the current AP MLD 502, e.g., as described below.

In some demonstrative aspects, the FT protocol may be configured to provide a technical solution to support a “zero roaming effect” for STA mobility, e.g., as described below.

In some demonstrative aspects, the STA 540 may be configured to set up association with the target AP MLD 550, for example, through the current AP MLD 502, for example, over a backhaul connection 590 between the current AP MLD 502 and the target AP MLD 550.

In some demonstrative aspects, as shown in FIG. 5, the STA MLD 540 may be configured to send a reassociation management frame to the current AP MLD 502, for example, over any available connected links between the STA 540 and the current AP MLD 502.

In some demonstrative aspects, as shown in FIG. 5, the current AP MLD 502 may forward the reassociation frame, which is received from the STA 540, to the target AP MLD 550, for example, through the backhaul connection 590.

In some demonstrative aspects, the FT protocol may be defined, for example, as enhanced over-the-DS FT protocol, for example, where a final reassociation request/response frame may be simplified.

In some demonstrative aspects, the FT protocol may be defined, for example, as a new tunneling mechanism, which may tunnel utilize the current AP MLD 502 to tunnel communications between the STA 540 and the target AP MLD 550.

In some demonstrative aspects, as shown in FIG. 5, the STA 540 may switch from the current AP MLD 502 to the target AP MLD 550 for communication via an associated session between the STA 540 and the target AP MLD 550.

In some demonstrative aspects, as shown in FIG. 5, the STA 540 may have a multi-link connection with the target AP MLD 550, for example, including a first link between the 2.4 GHz STA of the STA 540 and a 2.4 GHz AP of the AP MLD 550, and a second link between the 5 GHz STA of the STA 540 and a 5 GHz AP of the AP MLD 550.

In some demonstrative aspects, as shown in FIG. 5, the current AP MLD 502 may be configured to provide to the target AP MLD 550 a copy of buffered data packets for the STA MLD 502. For example, configuring the current AP MLD 502 to provide the buffered data packets to the target AP MLD 550 may provide a technical solution to support avoiding packet loss and/or extra delay, which may be caused by the FT to the target AP MLD 550.

In some demonstrative aspects, for example, once the STA MLD 540 switches to the target AP MLD 550 and there is still data left in current AP MLD 502, the STA MLD 540 may still be able to receive this data from the target AP MLD 550, for example, with low latency.

In some demonstrative aspects, the STA 540, the current AP MLD 502 and/or the target AP MLD 550 may be configured to support a reassociation triggering mechanism to trigger the reassociation management exchange of the reassociation request and the reassociation response between the STA 540 and the target AP MLD 550, e.g., as described below.

In some demonstrative aspects, the STA 540, the current AP MLD 502 and/or the target AP MLD 550 may be configured to support a STA-centric triggering mechanism to trigger the reassociation management exchange of the reassociation request and the reassociation response between the STA 540 and the target AP MLD 550.

In some demonstrative aspects, the STA 540 may be configured to trigger the reassociation management exchange based on one or more criteria.

In some demonstrative aspects, the STA 540 may be configured to trigger the reassociation management exchange, for example, based on a channel condition, e.g., a channel condition of a wireless communication channel between the STA 540 and the current AP MLD 502, and/or a channel condition of a wireless communication channel between the STA 540 and the target AP MLD 550.

In other aspects, STA 540 may be configured to trigger the reassociation management exchange based on any other additional or alternative criteria and/or parameter.

In some demonstrative aspects, the STA 540, the current AP MLD 502 and/or the target AP MLD 550 may be configured to support a network-centric triggering mechanism to trigger the reassociation management exchange of the reassociation request and the reassociation response between the STA 540 and the target AP MLD 550.

In some demonstrative aspects, the current AP MLD 502 may be configured to trigger the reassociation management exchange based on one or more criteria.

In some demonstrative aspects, the reassociation management exchange may be triggered, for example, by a central controller or a network controller, based on one or more criteria.

In some demonstrative aspects, the reassociation management exchange may be triggered, for example, based on a location of the STA.

In some demonstrative aspects, the reassociation management exchange may be triggered, for example, based on channel conditions at the current AP MLD 502.

In some demonstrative aspects, the reassociation management exchange may be triggered, for example, based on channel conditions at the target AP MLD 550.

In some demonstrative aspects, the reassociation management exchange may be triggered, for example, based on a traffic load at the current AP MLD 502.

In some demonstrative aspects, the reassociation management exchange may be triggered, for example, based on a traffic load at the target AP MLD 550.

In other aspects, the reassociation management exchange may be triggered based on any other additional or alternative criteria and/or parameter corresponding to the STA 540, the current AP MLD 502, and/or the target AP MLD 550.

In some demonstrative aspects, the STA 540, the current AP MLD 502 and/or the target AP MLD 550 may be configured to support an AP-switch triggering mechanism to trigger the switching of the STA 540 from the current AP MLD 502 to the target AP MLD 550, e.g., as described below.

In some demonstrative aspects, the STA 540 may be configured to decide to switch from the current AP MLD 502 to the target AP MLD 550.

In some demonstrative aspects, the STA 540 may be configured to decide to switch from the current AP MLD 502 to the target AP MLD 550, for example, based on a channel condition, e.g., a channel condition of a wireless communication channel between the STA 540 and the current AP MLD 502, and/or a channel condition of a wireless communication channel between the STA 540 and the target AP MLD 550.

In some demonstrative aspects, the STA 540 may be configured to trigger the switch from the current AP MLD 502 to the target AP MLD 550, for example, based on a management frame exchange, e.g., a single management frame exchange, with the target AP MLD 550.

In some demonstrative aspects, the STA 540, the current AP MLD 502 and/or the target AP MLD 550 may be configured to support a buffering mechanism to identify how much data buffered in the current AP MLD 502 is to be shared with the target AP MLD 550.

In some demonstrative aspects, the buffering mechanism may be implementation specific.

In some demonstrative aspects, the current AP MLD 502 may be configured to share all the data that is buffered for the STA MLD 540 at the current AP MLD 502 with the target AP MLD 550, for example, once the STA MLD 540 starts or completes the roaming procedure.

In some demonstrative aspects, the current AP MLD 502 may be configured to share only some of the data that is buffered for the STA MLD 540 at the current AP MLD 502 with the target AP MLD 550, for example, once the STA MLD 540 starts or completes the roaming procedure.

In some demonstrative aspects, the STA 540 may be configured to transmit a message to the current AP MLD 502 to indicate an amount of buffered data to be sent to the target AP MLD 550. For example, the current AP MLD 502 may be configured to share with the target AP MLD 550 the amount of data indicated by the ST 540.

In some demonstrative aspects, the STA 540, the current AP MLD 502 and/or the target AP MLD 550 may be configured to support a duplicate packet elimination mechanism to eliminate duplicate packets received by the STA 540 from both the current AP MLD 502 and the target AP MLD 550.

In some demonstrative aspects, the duplicate packet elimination mechanism may be implementation specific.

In some demonstrative aspects, the duplication packet elimination may be processed at a higher layer, for example, in case the current AP MLD 502 and the target AP MLD 550 use independent Block Acknowledgement (BA) agreements.

In some demonstrative aspects, the STA 540, the current AP MLD 502 and/or the target AP MLD 550 may be configured to support a capability indication mechanism to indicate a capability of the current AP MLD 502 and/or the target AP MLD 550 to support the FT protocol utilizing the backhaul connection 590.

In some demonstrative aspects, the current AP MLD 502 may be configured to indicate to the STA 540 a capability of the current AP MLD 502 to support the FT protocol utilizing the backhaul connection 590.

In some demonstrative aspects, the current AP MLD 502 may be configured to configure a beacon frame transmitted by the current AP MLD 502 to indicate the capability of the current AP MLD 502 to support the FT protocol utilizing the backhaul connection 590.

In some demonstrative aspects, the current AP MLD 502 may be configured to configure a frame transmitted by the current AP MLD 502 during the association process to the STA MLD 540 to indicate the capability of the current AP MLD 502 to support the FT protocol utilizing the backhaul connection 590.

In some demonstrative aspects, the current AP MLD 502 may be configured to indicate to the STA 540 a capability of the target AP MLD 550 to support the FT protocol utilizing the backhaul connection 590.

In some demonstrative aspects, the current AP MLD 502 may be configured to indicate to the STA 540 that the current AP MLD 502 can support the FT protocol utilizing the backhaul connection 590 with a particular AP or AP MLD, e.g., the target AP MLD 550.

In some demonstrative aspects, the current AP MLD 502 may be configured to set a capability field, for example, in a neighbor report describing a neighbor AP, and/or in a Reduced Neighbor Report element describing the neighbor AP, for example, to indicate that the current AP MLD 502 can support the FT protocol utilizing the backhaul connection 590 with the neighbor AP, e.g., the target AP MLD 550.

In some demonstrative aspects, the STA 540, the current AP MLD 502 and/or the target AP MLD 550 may be configured to support an agreement setup mechanism to setup an agreement for communication between the STA 540 and the target AP MLD 550.

In some demonstrative aspects, STA 540 and target AP MLD 550 may be configured to communicate an agreement setup message via the current AP MLD 502, for example, prior to the STA 540 switching from the current AP MLD 502 to the target AP MLD 550. For example, the current AP MLD 502 and the target AP MLD 550 may communicate the agreement setup message via the backhaul connection 590.

In some demonstrative aspects, the agreement message may include an ADDBA message to setup an ADDBA agreement.

In some demonstrative aspects, the agreement message may include a TWT message to setup a TWT agreement.

In other aspects, the agreement message may include any other additional or alternative type of message to setup any other additional or alternative agreement.

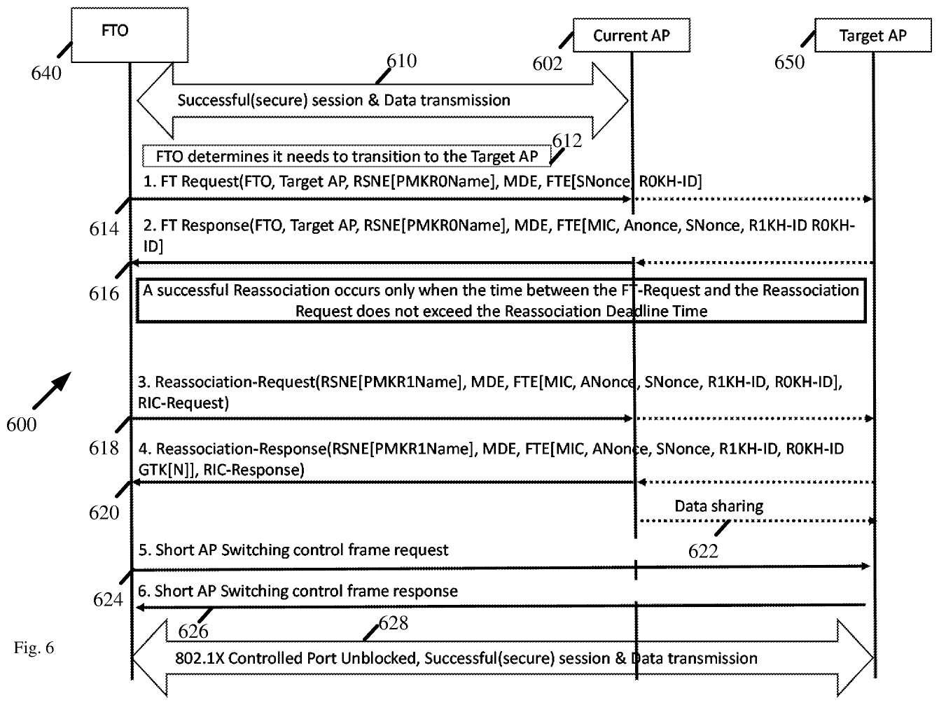

FIG. 6 is a schematic illustration of communications and operations according to an FT protocol 600, in accordance with some demonstrative aspects.

In some demonstrative aspects, one or more operations of the FT protocol 600 may be performed by an FTO STA 640, a current AP 602 and a target AP 650, for example, to move the FTO STA 640 from the current AP 602 to the target AP 650, e.g., as described below. In one example, device 140 (FIG. 1) may perform one or more operations of, one or more functionalities of, the role of, and/or the functionality of, FTO STA 640. In one example, device 102 (FIG. 1) may perform one or more operations of, one or more functionalities of, the role of, and/or the functionality of, current AP 602. In one example, device 150 (FIG. 1) may perform one or more operations of, one or more functionalities of, the role of, and/or the functionality of, target AP 650.

In some demonstrative aspects, as shown in FIG. 6, the FTO STA 640 may be associated with the current AP 602 and may setup a session 610, e.g., a secure session, with the current AP 602, for example, to support data transmission between the FTO STA 640 and the current AP 602.

In some demonstrative aspects, as shown in FIG. 6, the FTO STA 640 may determine (612) that the FTO STA is to transition to the target AP 650, for example, based on a channel condition of a wireless communication channel between the FTO STA 640 and the current AP 602, and/or based on any other condition and/or criterion.

In some demonstrative aspects, as shown in FIG. 6, the FTO STA 640 may transmit an FT request 614 to the target AP 650 via the current 602, for example, to request an FT of the FTO STA 640 from the current AP 602 to the target AP 650.

In some demonstrative aspects, as shown in FIG. 6, the current AP 602 may communicate the FT request 614 between FTO STA 640 and the target AP 650, e.g., via the current AP 602.

In some demonstrative aspects, as shown in FIG. 6, the target AP 650 may process the FT request 614 received from the FTO STA 640 via the current AP 602.

In some demonstrative aspects, as shown in FIG. 6, the target AP 650 may transmit an FT response 616 to the FTO STA via the current AP 602, for example, after the FT request 614.

In some demonstrative aspects, as shown in FIG. 6, the current AP 602 may communicate the FT response 616 between the target AP 650 and the FTO STA 640, e.g., via the current AP 602.

In some demonstrative aspects, as shown in FIG. 6, the FTO STA 640 may process the FT response 616 received by the FTO STA 640 via the current AP 602.

In some demonstrative aspects, as shown in FIG. 6, the FTO STA 640 may transmit a reassociation request 618 to the target AP 650 via the current AP 602, for example, after the FT response 616. For example, the reassociation request 618 may be configured to request to associate between the FTO STA 640 and the target AP 650.

In some demonstrative aspects, as shown in FIG. 6, the current AP 602 may communicate the reassociation request 618 between the FTO STA 640 and the target AP 650, e.g., via the current AP 602.

In some demonstrative aspects, as shown in FIG. 6, the target AP 650 may process the reassociation request 618 received from the FTO STA 640 via the current AP 602.

In some demonstrative aspects, as shown in FIG. 6, the target AP 650 may transmit a reassociation response 620 to the FTO STA 640 via the current AP 602, for example, after the reassociation request 618.

In some demonstrative aspects, as shown in FIG. 6, the current AP 602 may communicate the reassociation response 620 between the target AP 650 and the FTO STA 640, e.g., via the current AP 602.

In some demonstrative aspects, as shown in FIG. 6, the FTO STA 640 may process the reassociation response 620 received by the FTO STA 640 via the current AP 602.

In some demonstrative aspects, as shown in FIG. 6, the FTO STA 640 may switch from the current AP 602 to the target AP 650 for communication via an associated session 628 between the FTO STA 640 and the target AP 650.

In some demonstrative aspects, as shown in FIG. 6, the target AP 650 may communicate with the FTO STA 640 via the associated session 628 between the FTO STA 640 and the target AP 650.

In some demonstrative aspects, as shown in FIG. 6, the FTO STA 640 may transmit an AP switch request 624 to the target AP 650, for example, after the reassociation response 620. For example, the AP switch request 624 may be configured request to switch the FTO STA 640 to the target AP 650 for communication via the associated session 628 between the FTO STA 640 and the target AP 650.

In some demonstrative aspects, as shown in FIG. 6, the target AP 650 may process the AP switch request 624 from the FTO STA 640, for example, after the reassociation response 620.

In some demonstrative aspects, as shown in FIG. 6, the target AP 650 may transmit an AP switch response 626 to the FTO STA 640, for example, to confirm the request to switch the FTO STA 640 to the target AP 650.

In some demonstrative aspects, as shown in FIG. 6, the current AP 602 may transmit one or more buffered data packets 622 to the target AP 650. For example, the buffered data packets 622 may include data for the FTO STA 640 buffered by the current AP 602, for example, prior to the FTO STA 640 switching from the current AP 602 to the target AP 650.

In some demonstrative aspects, the target AP 650 may transmit the buffered data packets 622 to the FTO STA 640, for example, via the associated session 628 between the FTO STA 640 and the target AP 650.

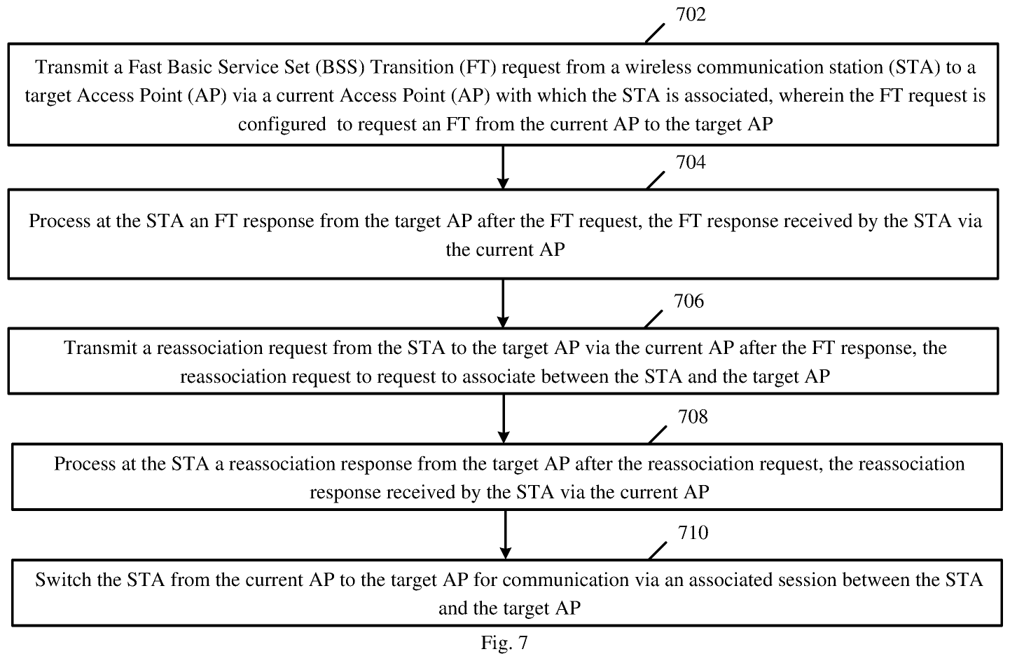

FIG. 7 is a schematic flow-chart illustration of a method of FT, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1), device 140 (FIG. 1), and/or device 150 (FIG. 1), an MLD, e.g., MLD 131 (FIG. 1), MLD 179 (FIG. 1), and/or MLD 151 (FIG. 1), a controller, e.g., controller 124 (FIG. 1), controller 174 (FIG. 1), and/or controller 154 (FIG. 1), a radio, e.g., radio 114 (FIG. 1), radio 173 (FIG. 1), and/or radio 144 (FIG. 1), and/or a message processor, e.g., message processor 128 (FIG. 1), message processor 178 (FIG. 1), and/or message processor 158 (FIG. 1).

As indicated at block 702, the method may include transmitting an FT request from a STA to a target AP via a current AP with which the STA is associated. For example, the FT request may be configured to request an FT from the current AP to the target AP. For example, controller 154 (FIG. 1) may be configured to cause, trigger, and/or control device 140 (FIG. 1) to transmit the FT request 614 (FIG. 6) to the target AP 650 (FIG. 6) via the current AP 602 (FIG. 6), e.g., as described above.

As indicated at block 704, the method may include processing at the STA an FT response from the target AP, for example, after the FT request. For example, the FT response may be received by the STA via the current AP. For example, controller 154 (FIG. 1) may be configured to cause, trigger, and/or control device 140 (FIG. 1) to process the FT response 616 (FIG. 6) received from the target AP 650 (FIG. 6) via the current AP 602 (FIG. 6), e.g., as described above.

As indicated at block 706, the method may include transmitting a reassociation request from the STA to the target AP via the current AP after the FT response, for example, to request to associate between the STA and the target AP. For example, controller 154 (FIG. 1) may be configured to cause, trigger, and/or control device 140 (FIG. 1) to transmit the reassociation request 618 (FIG. 6) to the target AP 650 (FIG. 6) via the current AP 602 (FIG. 6), e.g., as described above.

As indicated at block 708, the method may include processing at the STA a reassociation response from the target AP, for example, after the reassociation request. For example, the reassociation response may be received by the STA via the current AP. For example, controller 154 (FIG. 1) may be configured to cause, trigger, and/or control device 140 (FIG. 1) to process the reassociation response 620 (FIG. 6) received from the target AP 650 (FIG. 6) via the current AP 602 (FIG. 6), e.g., as described above.

As indicated at block 710, the method may include switching the STA from the current AP to the target AP, for example, for communication via an associated session between the STA and the target AP. For example, controller 154 (FIG. 1) may be configured to cause, trigger, and/or control device 140 (FIG. 1) to switch from the current AP 602 (FIG. 6) to the target AP 650 (FIG. 6), for example, for communication via the associated session 628 (FIG. 6), e.g., as described above.

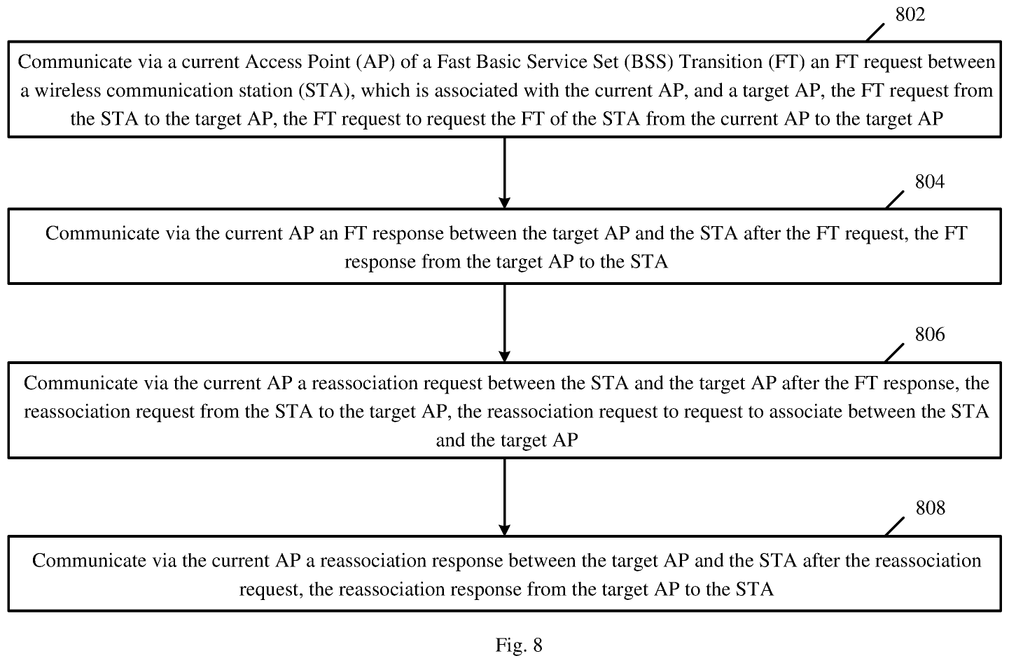

FIG. 8 is a schematic flow-chart illustration of a method of FT, in accordance with some demonstrative aspects. For example, one or more of the operations of the method of FIG. 8 may be performed by one or more elements of a system, e.g., system 100 (FIG. 1), for example, one or more wireless devices, e.g., device 102 (FIG. 1), device 140 (FIG. 1), and/or device 150 (FIG. 1), an MLD, e.g., MLD 131 (FIG. 1), MLD 179 (FIG. 1), and/or MLD 151 (FIG. 1), a controller, e.g., controller 124 (FIG. 1), controller 174 (FIG. 1), and/or controller 154 (FIG. 1), a radio, e.g., radio 114 (FIG. 1), radio 173 (FIG. 1), and/or radio 144 (FIG. 1), and/or a message processor, e.g., message processor 128 (FIG. 1), message processor 178 (FIG. 1), and/or message processor 158 (FIG. 1).

As indicted at block 802, the method may include communicating, via a current AP of an FT, an FT request between a STA, which is associated with the current AP, and a target AP. For example, the FT request may be from the STA to the target AP. For example, the FT request may be configured to request the FT of the STA from the current AP to the target AP. For example, controller 102 (FIG. 1) may be configured to cause, trigger, and/or control device 102 (FIG. 1) to communicate the FT request 614 (FIG. 6) between the FTO STA 640 (FIG. 6) and the target AP 650 (FIG. 6), e.g., as described above.

As indicted at block 804, the method may include communicating, via the current AP, an FT response between the target AP and the STA, for example, after the FT request. For example, the FT response may be from the target AP to the STA. For example, controller 102 (FIG. 1) may be configured to cause, trigger, and/or control device 102 (FIG. 1) to communicate the FT response 616 (FIG. 6) between the target AP 650 (FIG. 6) and the FTO STA 640 (FIG. 6), e.g., as described above.

As indicted at block 806, the method may include communicating, via the current AP, a reassociation request between the STA and the target AP, for example, after the FT response. For example, the reassociation request may be from the STA to the target AP. For example, the reassociation request may be configured to request to associate between the STA and the target AP. For example, controller 102 (FIG. 1) may be configured to cause, trigger, and/or control device 102 (FIG. 1) to communicate the reassociation request 618 (FIG. 6) between the FTO STA 640 (FIG. 6) and the target AP 650 (FIG. 6), e.g., as described above.

As indicted at block 808, the method may include communicating, via the current AP, a reassociation response between the target AP and the STA, for example, after the reassociation request. For example, the reassociation response may be from the target AP to the STA. For example, controller 102 (FIG. 1) may be configured to cause, trigger, and/or control device 102 (FIG. 1) to communicate the reassociation response 320 (FIG. 6) between the target AP 650 (FIG. 6) and the FTO STA 640 (FIG. 6), e.g., as described above.

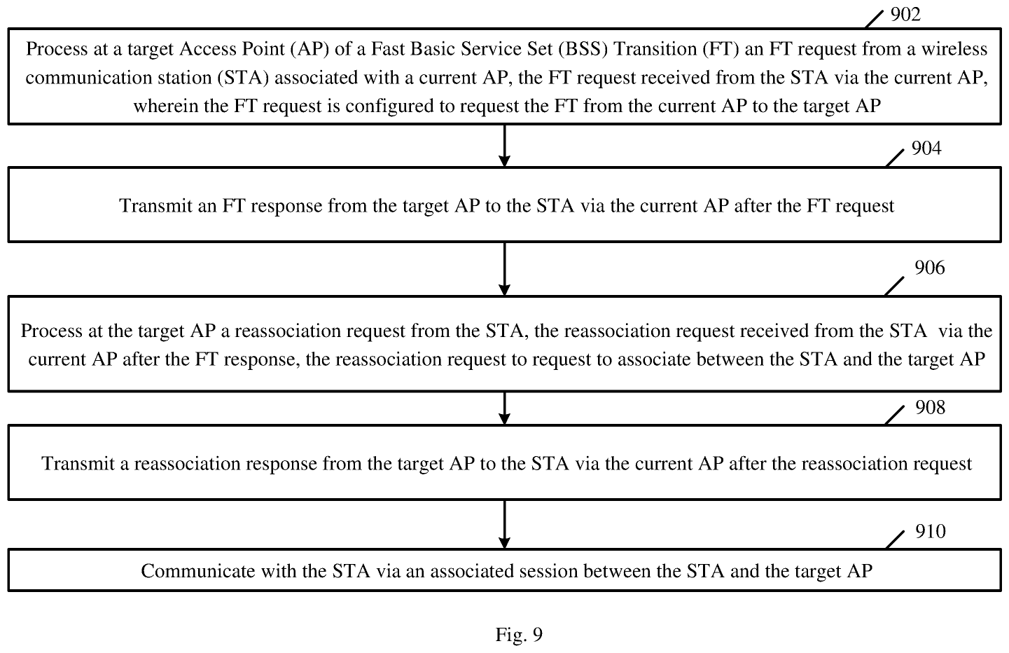

FIG. 9 is a schematic flow-chart illustration of a method of FT, in accordance with some demonstrative aspects. For example, one or more of the operations of the method of FIG. 9 may be performed by one or more elements of a system, e.g., system 100 (FIG. 1), for example, one or more wireless devices, e.g., device 102 (FIG. 1), device 140 (FIG. 1), and/or device 150 (FIG. 1), an MLD, e.g., MLD 131 (FIG. 1), MLD 179 (FIG. 1), and/or MLD 151 (FIG. 1), a controller, e.g., controller 124 (FIG. 1), controller 174 (FIG. 1), and/or controller 154 (FIG. 1), a radio, e.g., radio 114 (FIG. 1), radio 173 (FIG. 1), and/or radio 144 (FIG. 1), and/or a message processor, e.g., message processor 128 (FIG. 1), message processor 178 (FIG. 1), and/or message processor 158 (FIG. 1).

As indicted at block 902, the method may include processing, at a target AP of an FT, an FT request from a STA associated with a current AP, the FT request received from the STA via the current AP. For example, the FT request may be configured to request the FT from the current AP to the target AP. For example, controller 174 (FIG. 1) may be configured to cause, trigger, and/or control device 150 (FIG. 1) to process the FT request 614 (FIG. 6) received from the FTO STA 640 (FIG. 6) via the current AP 602 (FIG. 6), e.g., as described above.

As indicated at block 904, the method may include transmitting an FT response from the target AP to the STA via the current AP, for example, after the FT request. For example, controller 174 (FIG. 1) may be configured to cause, trigger, and/or control device 150 (FIG. 1) to transmit the FT response 616 (FIG. 6) to the FTO STA 640 (FIG. 6) via the current AP 602 (FIG. 6), e.g., as described above.

As indicated at block 906, the method may include processing at the target AP a reassociation request from the STA. For example, the reassociation request may be received from the STA via the current AP, for example, after the FT response. For example, the reassociation request may be configured to request to associate between the STA and the target AP. For example, controller 174 (FIG. 1) may be configured to cause, trigger, and/or control device 150 (FIG. 1) to process the reassociation request 618 (FIG. 6) received from the FTO STA 640 (FIG. 6) via the current AP 602 (FIG. 6), e.g., as described above.

As indicated at block 908, the method may include transmitting a reassociation response from the target AP to the STA via the current AP, for example, after the reassociation request. For example, controller 174 (FIG. 1) may be configured to cause, trigger, and/or control device 150 (FIG. 1) to transmit the reassociation response 620 (FIG. 6) to the FTO STA 640 (FIG. 6) via the current AP 602 (FIG. 6), e.g., as described above.

As indicated at block 910, the method may include communicating with the STA via an associated session between the STA and the target AP. For example, controller 174 (FIG. 1) may be configured to cause, trigger, and/or control device 150 (FIG. 1) to communicate with the FTO STA 640 (FIG. 6) via the associated session 628 (FIG. 6), e.g., as described above.

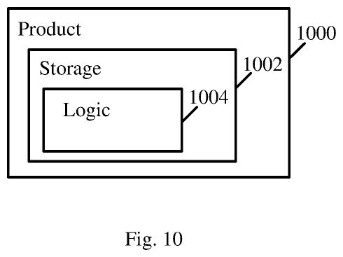

Reference is made to FIG. 10, which schematically illustrates a product of manufacture 1000, in accordance with some demonstrative aspects. Product 1000 may include one or more tangible computer-readable (“machine-readable”) non-transitory storage media 1002, which may include computer-executable instructions, e.g., implemented by logic 1004, operable to, when executed by at least one computer processor, enable the at least one computer processor to implement one or more operations at device 102 (FIG. 1), device 140 (FIG. 1), device 150 (FIG. 1), MLD 131 (FIG. 1), MLD 179 (FIG. 1), MLD 151 (FIG. 1), radio 114 (FIG. 1), radio 173 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 178 (FIG. 1), message processor 158 (FIG. 1), controller 124 (FIG. 1), controller 174 (FIG. 1), and/or controller 154 (FIG. 1); to cause device 102 (FIG. 1), device 140 (FIG. 1), device 150 (FIG. 1), MLD 131 (FIG. 1), MLD 179 (FIG. 1), MLD 151 (FIG. 1), radio 114 (FIG. 1), radio 173 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 178 (FIG. 1), message processor 158 (FIG. 1), controller 124 (FIG. 1), controller 174 (FIG. 1), and/or controller 154 (FIG. 1) to perform, trigger and/or implement one or more operations and/or functionalities, and/or to perform, trigger and/or implement one or more operations and/or functionalities described with reference to the FIGS. 1, 2, 3, 4, 5, 6, 7, 8 and/or 9, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1000 and/or machine-readable storage media 1002 may include one or more types of computer-readable storage media capable of storing data, including volatile memory, non-volatile memory, removable or non-removable memory, erasable or non-erasable memory, writeable or re-writeable memory, and the like. For example, machine-readable storage media 1002 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1004 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1004 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a wireless communication station (STA) to transmit a Fast Basic Service Set (BSS) Transition (FT) request to a target Access Point (AP) via a current AP with which the STA is associated, wherein the FT request is configured to request an FT from the current AP to the target AP; process an FT response from the target AP after the FT request, the FT response received by the STA via the current AP; transmit a reassociation request to the target AP via the current AP after the FT response, the reassociation request to request to associate between the STA and the target AP; process a reassociation response from the target AP after the reassociation request, the reassociation response received by the STA via the current AP; and switch the STA from the current AP to the target AP for communication via an associated session between the STA and the target AP.

Example 2 includes the subject matter of Example 1, and optionally, wherein the apparatus is configured to cause the STA to process one or more buffered data packets received from the target AP via the associated session between the STA and the target AP, wherein the buffered data packets comprise data buffered by the current AP prior to the STA switching from the current AP to the target AP.

Example 3 includes the subject matter of Example 2, and optionally, wherein the apparatus is configured to cause the STA to transmit to the current AP a message comprising an indication of a criterion to send the buffered data packets to the target AP.

Example 4 includes the subject matter of Example 3, and optionally, wherein the criterion comprises an amount of the buffered data packets to be sent to the target AP.

Example 5 includes the subject matter of any one of Examples 1-4, and optionally, wherein the apparatus is configured to cause the STA to trigger transmission of the reassociation request to the target AP based on a channel condition of a wireless communication channel between the STA and the current AP.

Example 6 includes the subject matter of any one of Examples 1-5, and optionally, wherein the apparatus is configured to cause the STA to transmit an AP switch request to the target AP after the reassociation response, the AP switch request to request to switch the STA to the target AP for communication via the associated session between the STA and the target AP.

Example 7 includes the subject matter of Example 6, and optionally, wherein the apparatus is configured to cause the STA to process an AP switch response from the target AP, the AP switch response to confirm the request to switch the STA to the target AP for communication via the associated session between the STA and the target AP.

Example 8 includes the subject matter of any one of Examples 1-7, and optionally, wherein the apparatus is configured to cause the STA to identify, based on a capability indication in a message from the current AP, a capability of the current AP to support communication of the reassociation request and the reassociation response with the target AP.

Example 9 includes the subject matter of Example 8, and optionally, wherein the message from the current AP comprises a beacon from the current AP, or an association frame received from the current AP during association with the current AP.

Example 10 includes the subject matter of any one of Examples 1-9, and optionally, wherein the apparatus is configured to cause the STA to identify, based on a capability indication in a neighbor report element from the current AP, a capability of the target AP to support communication of the reassociation request and the reassociation response via the current AP.

Example 11 includes the subject matter of any one of Examples 1-10, and optionally, wherein the reassociation request and the reassociation response comprise tunneled messages according to a tunneling protocol between the STA and the target AP via the current AP.

Example 12 includes the subject matter of any one of Examples 1-11, and optionally, wherein the apparatus is configured to cause the STA to communicate an agreement setup message with the target AP via the current AP prior to the STA switching from the current AP to the target AP, wherein the agreement setup message is configured to setup an agreement for communication via the associated session between the STA and the target AP.

Example 13 includes the subject matter of Example 12, and optionally, wherein the agreement message comprises at least one of an Add Block Acknowledgement (ADDBA) message to setup an ADDBA agreement, or a Target Wake Time (TWT) message to setup a TWT agreement.

Example 14 includes the subject matter of any one of Examples 1-13, and optionally, wherein the FT comprises an FT over a Distribution System (DS) between the current AP and the target AP.

Example 15 includes the subject matter of any one of Examples 1-14, and optionally, wherein the STA comprises a non-AP Multi-Link Device (MLD) comprising a plurality of non-AP STAs.

Example 16 includes the subject matter of any one of Examples 1-15, and optionally, comprising at least one radio to communicate the FT request, the FT response, the reassociation request, and the reassociation response.

Example 17 includes the subject matter of Example 16, and optionally, comprising one or more antennas connected to the radio, and a processor to execute instructions of an operating system of the STA.

Example 18 includes an apparatus comprising logic and circuitry configured to cause a target Access Point (AP) of a Fast Basic Service Set (BSS) Transition (FT) to process an FT request from a wireless communication station (STA) associated with a current AP, the FT request received from the STA via the current AP, wherein the FT request is configured to request the FT from the current AP to the target AP; transmit an FT response to the STA via the current AP after the FT request; process a reassociation request from the STA, the reassociation request received from the STA via the current AP after the FT response, the reassociation request to request to associate between the STA and the target AP; transmit a reassociation response to the STA via the current AP after the reassociation request; and communicate with the STA via an associated session between the STA and the target AP.

Example 19 includes the subject matter of Example 18, and optionally, wherein the apparatus is configured to cause the target AP to process one or more buffered data packets received from the current AP, and to transmit the buffered data packets to the STA via the associated session between the STA and the target AP, wherein the buffered data packets comprise data packets buffered by the current AP prior to the STA switching from the current AP to the target AP.

Example 20 includes the subject matter of Example 18 or 19, and optionally, wherein the apparatus is configured to cause the target AP to process an AP switch request from the STA after the reassociation response, the AP switch request to request to switch the STA to the target AP for communication via the associated session between the STA and the target AP.

Example 21 includes the subject matter of Example 20, and optionally, wherein the apparatus is configured to cause the target AP to transmit an AP switch response to the STA, the AP switch response to confirm the request to switch the STA to the target AP for communication via the associated session between the STA and the target AP.

Example 22 includes the subject matter of any one of Examples 18-21, and optionally, wherein the apparatus is configured to cause the target AP to communicate an agreement setup message with the STA via the current AP prior to the STA switching from the current AP to the target AP, wherein the agreement setup message is configured to setup an agreement for communication via the associated session between the STA and the target AP.

Example 23 includes the subject matter of Example 22, and optionally, wherein the agreement message comprises at least one of an Add Block Acknowledgement (ADDBA) message to setup an ADDBA agreement, or a Target Wake Time (TWT) message to setup a TWT agreement.

Example 24 includes the subject matter of any one of Examples 18-23, and optionally, wherein the FT comprises an FT over a Distribution System (DS) between the current AP and the target AP.

Example 25 includes the subject matter of any one of Examples 18-24, and optionally, wherein the target AP comprises an AP Multi-Link Device (MLD) comprising a plurality of AP STAs.

Example 26 includes the subject matter of any one of Examples 18-25, and optionally, comprising at least one radio to communicate with the STA via the associated session between the STA and the target AP.

Example 27 includes the subject matter of Example 26, and optionally, comprising one or more antennas connected to the radio, and a processor to execute instructions of an operating system of the target AP.

Example 28 includes an apparatus comprising logic and circuitry configured to cause an Access Point (AP) to act as a current AP of a Fast Basic Service Set (BSS) Transition (FT) to communicate via the current AP an FT request between a wireless communication station (STA), which is associated with the current AP, and a target AP, the FT request from the STA to the target AP, the FT request to request the FT of the STA from the current AP to the target AP; communicate via the current AP an FT response between the target AP and the STA after the FT request, the FT response from the target AP to the STA; communicate via the current AP a reassociation request between the STA and the target AP after the FT response, the reassociation request from the STA to the target AP, the reassociation request to request to associate between the STA and the target AP; and communicate via the current AP a reassociation response between the target AP and the STA after the reassociation request, the reassociation response from the target AP to the STA.

Example 29 includes the subject matter of Example 28, and optionally, wherein the apparatus is configured to cause the current AP to transmit one or more buffered data packets to the target AP, wherein the buffered data packets comprise data for the STA buffered by the current AP prior to the STA switching from the current AP to the target AP.

Example 30 includes the subject matter of Example 29, and optionally, wherein the apparatus is configured to cause the current AP to identify, based on a message from the STA, a criterion to send the buffered data packets to the target AP.

Example 31 includes the subject matter of Example 30, and optionally, wherein the criterion comprises an amount of the buffered data packets to be sent to the target AP.

Example 32 includes the subject matter of any one of Examples 28-31, and optionally, wherein the apparatus is configured to cause the current AP to transmit a capability indication in a message from the current AP, the capability indication to indicate a capability of the current AP to support communication of the reassociation request and the reassociation response with the target AP.

Example 33 includes the subject matter of Example 32, and optionally, wherein the message from the current AP comprises a beacon from the current AP, or an association frame transmitted to the STA during association with the STA.

Example 34 includes the subject matter of any one of Examples 28-33, and optionally, wherein the apparatus is configured to cause the current AP to transmit a neighbor report element corresponding to the target AP, the neighbor report element comprising an indication of a capability of the target AP to support communication of the reassociation request and the reassociation response via the current AP.

Example 35 includes the subject matter of any one of Examples 28-34, and optionally, wherein the reassociation request and the reassociation response comprise tunneled messages according to a tunneling protocol between the STA and the target AP via the current AP.

Example 36 includes the subject matter of any one of Examples 28-35, and optionally, wherein the apparatus is configured to cause the current AP to communicate an agreement setup message between the STA and the target AP via the current AP prior to the STA switching from the current AP to the target AP, wherein the agreement setup message is configured to setup an agreement for communication via an associated session between the STA and the target AP.

Example 37 includes the subject matter of Example 36, and optionally, wherein the agreement message comprises at least one of an Add Block Acknowledgement (ADDBA) message to setup an ADDBA agreement, or a Target Wake Time (TWT) message to setup a TWT agreement.

Example 38 includes the subject matter of any one of Examples 28-37, and optionally, wherein the FT comprises an FT over a Distribution System (DS) between the current AP and the target AP.

Example 39 includes the subject matter of any one of Examples 28-38, and optionally, wherein the AP comprises an AP Multi-Link Device (MLD) comprising a plurality of AP STAs.

Example 40 includes the subject matter of any one of Examples 28-39, and optionally, comprising at least one radio to communicate the FT request, the FT response, the reassociation request, and the reassociation response with the STA.

Example 41 includes the subject matter of Example 40, and optionally, comprising one or more antennas connected to the radio, and a processor to execute instructions of an operating system of the AP.

Example 42 comprises a wireless communication device comprising the apparatus of any of Examples 1-41.

Example 43 comprises an apparatus comprising means for executing any of the described operations of any of Examples 1-41.

Example 44 comprises a product comprising one or more tangible computer-readable non-transitory storage media comprising computer-executable instructions operable to, when executed by at least one processor, enable the at least one processor to cause a wireless communication device to perform any of the described operations of any of Examples 1-41.

Example 45 comprises an apparatus comprising: a memory interface; and processing circuitry configured to: perform any of the described operations of any of Examples 1-41.

Example 46 comprises a method comprising any of the described operations of any of Examples 1-41.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1-25. (canceled)

26. An apparatus comprising logic and circuitry configured to cause a wireless communication station (STA) to:
transmit a Fast Basic Service Set (BSS) Transition (FT) request to a target Access Point (AP) via a current AP with which the STA is associated, wherein the FT request is configured to request an FT from the current AP to the target AP;
process an FT response from the target AP after the FT request, the FT response received by the STA via the current AP;
transmit a reassociation request to the target AP via the current AP after the FT response, the reassociation request to request to associate between the STA and the target AP;
process a reassociation response from the target AP after the reassociation request, the reassociation response received by the STA via the current AP; and
switch the STA from the current AP to the target AP for communication via an associated session between the STA and the target AP.

27. The apparatus of claim 26 configured to cause the STA to process one or more buffered data packets received from the target AP via the associated session between the STA and the target AP, wherein the buffered data packets comprise data buffered by the current AP prior to the STA switching from the current AP to the target AP.

28. The apparatus of claim 27 configured to cause the STA to transmit to the current AP a message comprising an indication of a criterion to send the buffered data packets to the target AP.

29. The apparatus of claim 28, wherein the criterion comprises an amount of the buffered data packets to be sent to the target AP.

30. The apparatus of claim 26 configured to cause the STA to trigger transmission of the reassociation request to the target AP based on a channel condition of a wireless communication channel between the STA and the current AP.

31. The apparatus of claim 26 configured to cause the STA to transmit an AP switch request to the target AP after the reassociation response, the AP switch request to request to switch the STA to the target AP for communication via the associated session between the STA and the target AP.

32. The apparatus of claim 31 configured to cause the STA to process an AP switch response from the target AP, the AP switch response to confirm the request to switch the STA to the target AP for communication via the associated session between the STA and the target AP.

33. The apparatus of claim 26 configured to cause the STA to identify, based on a capability indication in a message from the current AP, a capability of the current AP to support communication of the reassociation request and the reassociation response with the target AP.

34. The apparatus of claim 33, wherein the message from the current AP comprises a beacon from the current AP, or an association frame received from the current AP during association with the current AP.

35. The apparatus of claim 26 configured to cause the STA to identify, based on a capability indication in a neighbor report element from the current AP, a capability of the target AP to support communication of the reassociation request and the reassociation response via the current AP.

36. The apparatus of claim 26, wherein the reassociation request and the reassociation response comprise tunneled messages according to a tunneling protocol between the STA and the target AP via the current AP.

37. The apparatus of claim 26 configured to cause the STA to communicate an agreement setup message with the target AP via the current AP prior to the STA switching from the current AP to the target AP, wherein the agreement setup message is configured to setup an agreement for communication via the associated session between the STA and the target AP.

38. The apparatus of claim 37, wherein the agreement setup message comprises at least one of an Add Block Acknowledgement (ADDBA) message to setup an ADDBA agreement, or a Target Wake Time (TWT) message to setup a TWT agreement.

39. The apparatus of claim 26, wherein the FT comprises an FT over a Distribution System (DS) between the current AP and the target AP.

40. The apparatus of claim 26, wherein the STA comprises a non-AP Multi-Link Device (MLD) comprising a plurality of non-AP STAs.

41. The apparatus of claim 26 comprising at least one radio to communicate the FT request, the FT response, the reassociation request, and the reassociation response.

42. The apparatus of claim 41 comprising one or more antennas connected to the at least one radio, and a processor to execute instructions of an operating system.

43. A product comprising one or more tangible computer-readable non-transitory storage media comprising instructions operable to, when executed by at least one processor, enable the at least one processor to cause a wireless communication station (STA) to:
transmit a Fast Basic Service Set (BSS) Transition (FT) request to a target Access Point (AP) via a current AP with which the STA is associated, wherein the FT request is configured to request an FT from the current AP to the target AP;
process an FT response from the target AP after the FT request, the FT response received by the STA via the current AP;
transmit a reassociation request to the target AP via the current AP after the FT response, the reassociation request to request to associate between the STA and the target AP;
process a reassociation response from the target AP after the reassociation request, the reassociation response received by the STA via the current AP; and
switch the STA from the current AP to the target AP for communication via an associated session between the STA and the target AP.

44. The product of claim 43, wherein the instructions, when executed, cause the STA to trigger transmission of the reassociation request to the target AP based on a channel condition of a wireless communication channel between the STA and the current AP.

45. The product of claim 43, wherein the instructions, when executed, cause the STA to transmit an AP switch request to the target AP after the reassociation response, the AP switch request to request to switch the STA to the target AP for communication via the associated session between the STA and the target AP.
